(19) United States
(12) Patent Application Publication
(10) Pub. No.: US 2026/0146356 A1
(43) Pub. Date: May 28, 2026

(54) RHENIUM-COBALT ALLOY COMPOSITION AND PROCESS FOR EFFECTIVE METAL ELECTRODEPOSITION IN 3D-INTEGRATION

(71) Applicant: MacDermid Enthone Inc., Waterbury, CT (US)

(72) Inventors: Stephen Lombardo, Milford, CT (US); Wenbo Shao, New Canaan, CT (US); Eric Yakobson, East Haven, CT (US); Elie Najjar, Norwood, MA (US)

(21) Appl. No.: 18/961,636

(22) Filed: Nov. 27, 2024

(51) Int. Cl. C25D 3/56; B32B 15/01; C25D 5/50

(52) U.S. Cl. CPC C25D 3/56; B32B 15/01; C25D 5/505; B32B 2311/12; B32B 2311/16

(57) ABSTRACT

A method of creating one or more metal interconnects in an electronic device, wherein the electronic device comprises one or more features within which the one or more metal interconnects are created, the method comprising the steps of (a) depositing a copper layer on the one or more features; (b) depositing a rhenium-cobalt alloy layer on the copper layer; and (c) depositing a tin or tin alloy layer on the rhenium-cobalt alloy layer; wherein the rhenium-cobalt alloy layer comprises greater than 50 wt. % rhenium.

### FIELD OF THE INVENTION

The present invention relates generally to a rhenium-cobalt alloy composition and a method of using the same as a barrier layer in the production of integrated circuits.

### BACKGROUND OF THE INVENTION

The desire for ever-smaller integrated circuits places enormous performance demands on the materials used to construct interconnect devices. Integrated circuit chips (also known as microchips, silicon chips, or chips) are found in a number of common devices such as microprocessors in computers, cars, televisions, tablets, and smart phones.

Electronic connections between the electronic devices in an integrated circuit (IC) chip are generally created using copper metal or alloys of copper metals. Devices in an IC chip can be placed not only across the surface of the IC chip but can also be stacked in a plurality of layers on the IC chip.

Electrical interconnections between electronic devices that make up the IC chip are built using vias and trenches filled with a conducting material. Layer(s) of insulating materials, frequently, low-k dielectric materials, separate the various components and devices in the IC chip.

Metal electrodeposition processes are crucial in the production of ICs, where the deposition of various materials including, for example, copper and tin layers, is essential for the functionality of the device. The integration of these layers is achieved through a process called 3D-integration, which involves stacking multiple devices and circuit layers to improve IC chip performance.

3D packaging refers to 3D integration arrangements that rely on traditional methods of interconnect at the package level such as wire bonding and flip chip to achieve vertical stacks. Examples of 3D packages included package on package (POP) and 3D wafer-level packaging (3D WLP). In POP, individual die are packaged, and the packages are stacked and interconnected with wire bonds or flip chip processes, while in 3D WLP, redistribution layers (RDL) and bumping processes are used to form interconnects. These technologies enable increased interconnect bandwidth, enhanced performance, power and area, and may reduce costs.

3D integration offers specific advantages with regards to the integration of different components, including sensors, processors, memories, antennae, etc. The use of the third dimension not only allows for more compact packaging, but also for shorter electrical interconnects, which can make the entire system more powerful and efficient. Through silicon vias (TSVs) can be created in the devices at the wafer scale to enable vertical routing of electrical signals from their top side to their bottom side as well as subsequent vertical stacking.

3D integrated circuits (3D IC) with TSVs have implications for networking, graphics, mobile communications, and computing, especially for applications that require small, ultra-light and/or low-power devices. Specific applications include, for example, multi-core central processing units (CPUs), graphics processing units (GPUs), packet buffers/routers, smartphones, tablets, etc.

Advantages of 3D ICS with TSVs include, but are not limited to:
a. Lower costs;
b. Ability to meet high interconnect speeds and bandwidth requirements for advanced memory technologies;
c. Miniaturization, saving board space and end product space, and allowing for use in extremely compact mobile devices;
d. Reduced power requirements because significant drivers are not required. Additionally, reduced resistance-inductance-capacitance (RLC) helps reduce power;
e. Reduced interconnect between packages allows for faster performance and a better power profile; and
f. Integration of emerging technologies into 3D IC stacks.

Compared to wire bonding, TSVs offer reduced RLC parasitics, better performance, additional power savings, and a denser implementation. However, a 3D IC stack raises certain challenges including thermal, timing, and power management concerns.

Many microelectronic devices have bump bond structures with copper pillars and solder bumps on the copper pillars, to provide connections to lead frames and other package terminals. Increasing demand for miniaturization of the copper pillars and higher pillar densities has increased the current density through the copper pillars and the solder bumps. Electromigration failure in bump bond structures with solder directly contacting the copper pillars has been attributed to the depletion of intermetallic compounds at the interface of the copper and the solder, which usually contains tin. These failures have led to use of barrier layers between the copper and the solder. Nickel, nickel phosphorus, nickel phosphorus tungsten, nickel iron phosphorus, nickel rhenium phosphorus, cobalt phosphorus, and cobalt tungsten phosphorus, have been reported as potential candidates for the barrier layer, all of which suffer from disadvantages. Nickel forms a brittle intermetallic compound of Ni₃Sn₄ which can pose reliability issues. Even though a thin nickel layer on copper can reduce the interfacial reactions with tin-rich solders at a low reflow temperature, it may not be so effective when a reflow process is performed at a higher temperature and for a longer period. Other barrier layer compositions react with tin-rich solder, leading to formation of brittle intermetallic compounds, resulting in fractures or voids in the bump bond structure.

### SUMMARY OF THE INVENTION

It is an object of the present invention to provide a barrier layer suitable for use between copper and tin layers.

It is another object of the present invention to provide an effective barrier layer that is capable of reducing the growth rate of intermetallic compounds.

It is another object of the present invention to provide a rhenium-cobalt alloy barrier layer.

It is another object of the present invention to provide a rhenium-cobalt alloy barrier layer that contains a high percentage of rhenium that can be deposited by electrodeposition.

It is another object of the present invention to provide a rhenium-cobalt alloy barrier layer that contains greater than 50 wt. % rhenium.

It is still another object of the present invention of the present invention to provide a rhenium-cobalt alloy barrier layer that maintains a stable interface.

To that end, in one embodiment, the present invention relates generally to a method of creating one or more metal interconnects in an electronic device, wherein the electronic device comprises one or more features within which the one or more metal interconnects are created, the method comprising the steps of:
1. depositing a copper layer on the one or more features;
2. depositing a rhenium-cobalt alloy layer on the copper layer; and
3. depositing a tin or tin alloy layer on the rhenium-cobalt alloy layer;
   wherein the rhenium-cobalt alloy layer comprises greater than 50 wt. % rhenium.

In another embodiment, the present invention also relates generally to an electronic device comprising one or more electrical interconnections, wherein the one or more electrical interconnections comprise one or more features filled with a conducting material, wherein the conducting material comprises:
1. a copper layer;
2. a rhenium-cobalt alloy barrier layer deposited on the copper layer, wherein the rhenium-cobalt alloy barrier layer comprises greater than 50 wt. % rhenium; and
3. a tin containing layer deposited on the rhenium-cobalt alloy barrier layer.

### BRIEF DESCRIPTION OF THE DRAWINGS

The accompanying figures illustrate several aspects of the disclosure, and together with the description, illustrate various aspects of the present invention.

FIG. 1 depicts an FIB cross-section of a test coupon in accordance with Example 1.

FIG. 2 depicts an FIB cross-section of a test coupon in accordance with Comparative Example 2.

FIG. 3 depicts an FIB cross-section of a test coupon in accordance with Example 3.

FIG. 4 depicts an FIB cross-of a test coupon in accordance with Comparative Example 4.

FIG. 5 depicts an FIB cross-section of a test coupon in accordance with Example 5.

FIG. 6 depicts an FIB cross-of a test coupon in accordance with Example 6.

FIG. 7 depicts an FIB cross-section of a test coupon in accordance with Comparative Example 7.

FIG. 8 depicts an FIB cross-section of a test coupon in accordance with Example 8.

### DETAILED DESCRIPTION OF THE PREFERRED EMBODIMENTS

Electronic connections between electronic devices (e.g., transistors) in an IC chip are currently typically created using copper metal or alloys of copper metal. As discussed above, devices in an IC chip can be placed not only across the surface of the IC chip, but devices can also be stacked in a plurality of layers on the IC chip. Electrical interconnections between electronic devices that make up the IC chip are built using vias and trenches that are filled with conducting material. Layer(s) of insulating materials, such as low-k dielectric materials, separate the various components and devices in the IC chip.

The substrate on which the devices of the IC chip may be built is, for example, a silicon wafer or a silicon-on-insulator substrate. Silicon wafers are substrates that are typically used in the semiconductor processing industry, although embodiments of the invention are not dependent on the type of substrate used. The substrate may also comprise germanium, indium antimonide, lead telluride, indium arsenide, indium phosphide, gallium arsenide, gallium antimonide, and or other Group III-V materials either alone or in combination with silicon or silicon dioxide or other insulating materials. Devices that make up the IC chip are built on the substrate surface.

At least one dielectric layer is deposited on the substrate. Dielectric materials include, but are not limited to, silicon dioxide (SiO₂), low-k dielectrics, silicon nitrides, and or silicon oxynitrides. The dielectric layer optionally includes pores or other voids to further reduce its dielectric constant. Typically, low-k films are considered to be any film with a dielectric constant smaller than that of SiO₂ which has a dielectric constant of about 4.0. Low-k films having dielectric constants of about 3 to about 2.7 are typical of current semiconductor fabrication processes. The production of integrated circuit device structures often also includes placing a SiO₂ film or layer, or capping layer on the surface of low-k (low dielectric constant) ILD (inter-layer dielectric) films. Low-k films can be, for example, boron, phosphorous, or carbon doped silicon oxides. Carbon-doped silicon oxides can also be referred to as carbon-doped oxides (CDOs) and organo-silicate glasses (OSGs).

To form electrical interconnects, dielectric layers are patterned to create one or more trenches and or vias (i.e., features) within which conductive metal interconnects are formed. In general, a feature used to form a metal interconnect may be a depression having any shape formed in a substrate or layer deposited on the substrate. The feature is filled with conducting interconnect material. Trenches and or vias may be patterned (created) using conventional wet or dry etch semiconductor processing techniques. Dielectric materials are used to electrically isolate metal interconnects from the surrounding components. Barrier layers are used between the metal interconnects and the dielectric materials to prevent metal (i.e., copper) migration into the surrounding materials. Device failure can occur, for example, in situations in which copper metal is in contact with dielectric materials because the copper metal can ionize and penetrate into the dielectric material. Barrier layers placed between a dielectric material (i.e., silicon, and/or other materials) and the copper interconnect can also serve to promote adhesion of the copper to the other material(s). Delamination (due to poor adherence between materials) is also a difficulty encountered in the fabrication of IC chips that leads to device failure.

The metal interconnects may include one or more conductive metal layers such as one or more copper layers and one or more tin layers. In addition, it is common to use a barrier layer between the copper and tin layers of the metal interconnects to prevent the interdiffusion of the two layers, which can lead to the formation of brittle intermetallic compounds (IMCs), resulting in fractures or voids that can negatively impact the mechanical and electrical properties of the IC device. These barrier layers may be, for example, nickel or nickel alloy or cobalt or cobalt alloy.

Despite the effectiveness of these barrier layers, there are still several challenges that must be addressed. One of the main issues is the reduction in the total volume of solder available for IMC formation as the geometries of microbumps shrink. This reduction in solder volume makes the copper-barrier-tin stack interaction more critical, and thus, the need for an effective barrier to reduce the growth rate of IMC and the need for a stable interface are critical.

To combat this issue, rhenium-cobalt alloy barrier layers have been developed which have been shown to form thinner IMCs during reflow and/or high temperature storage, suppressing the growth of cobalt IMCs. However, while rhenium-cobalt alloy barriers have been shown to be effective, the process of adding rhenium at a high concentration as an alloying metal in the cobalt diffusion barrier is complex and requires precise control to ensure that the desired properties are achieved, especially during reflow and/or high temperature storage. That is, in order to produce a rhenium-cobalt alloy barrier layer with the desired characteristics, the rhenium-cobalt alloy barrier layer after reflow and/or high temperature storage must contain at least 50 wt. % rhenium and there must not be any diffusion of components of the barrier layer up into the copper layer.

Rhenium is a refractory metal element. Due to its physical properties, rhenium is close to Group VI refractory metals, has high specific resistance, and is paramagnetic. Rhenium differs from other refractory metals (e.g., Nb, Ta, Mo, and W) in that it has a hexagonal close-packed crystal structure and does not form carbides. Its structure eliminates the transition from toughness to brittleness and allows rhenium metal to maintain high toughness and strength from sub-zero to high temperatures. Rhenium also has one of the highest melting points of all elements at approximately 3180° C., a boiling point of approximately 5870° C., and a very high modulus of elasticity at approximately 461-471 GPa.

The present invention provides a solution to the problem of the complexity and precision required to produce a rhenium-cobalt alloy barrier layer than contains rhenium in higher than 50 wt. % concentration and that is capable of effectively reducing intermetallic compound growth rate and maintaining a stable interface even after reflow and high temperature storage. In addition, the present invention provides a solution to the technical problem of reduction in total volume of solder available for intermetallic compound formation as the geometries of microbumps shrink. The present invention also provides a solution to the problem of increased criticality of the copper-barrier-solder stack interaction due to the reduced solder volume.

As used herein, “a,” “an,” and “the” refer to both singular and plural referents unless the context clearly dictates otherwise.

As used herein, the terms “comprises,” “comprising,” “includes” and/or “including” specify the presence of stated features, integers, steps, operations, elements, and/or components, but do not preclude the presence or addition of one or more other features, integers, steps, operations, elements, components, and/or groups thereof.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform herein. Furthermore, it is also to be understood that the value to which the modifier “about” refers is itself specifically disclosed herein.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations in addition to the orientation depicted in the Figures.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein the term “substantially-free” or “essentially-free” if not otherwise defined herein for a particular element or compound means that a given element or compound is not detectable by ordinary analytical means that are well known to those skilled in the art of metal plating for bath analysis. Such methods typically include atomic absorption spectrometry, titration, UV-Vis analysis, secondary ion mass spectrometry, and other commonly available analytically methods.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In one embodiment, the present invention relates generally to a method of creating one or more metal interconnects in an electronic device, wherein the electronic device comprises one or more features within which the one or more metal interconnects are created, the method comprising the steps of:
a. depositing a copper layer on the one or more features;
b. depositing a rhenium-cobalt alloy layer on the copper layer; and
c. depositing a tin or tin alloy layer on the rhenium-cobalt alloy layer;
   wherein the rhenium-cobalt alloy layer comprises greater than 50 wt. % rhenium.

In one embodiment, the rhenium-cobalt alloy layer comprises greater than 60 wt. % rhenium, or greater than 70 wt. % rhenium, or greater than 80 wt. % rhenium, or greater than 90 wt. % rhenium.

In one embodiment, the rhenium-cobalt alloy layer is formed by bringing the electronic device as a cathode and an anode into contact with an electroplating composition to electrodeposit the rhenium-cobalt alloy layer on the copper layer of the electronic device.

In one embodiment, the electroplating composition comprises:
i. a source of cobalt ions;
ii. a source of rhenium ions;
iii. optionally, a complexing agent;
iv. one or more additives selected from the group consisting suppressors, uniformity enhancers, depolarizing compounds, levelers, accelerators, surfactants, wetting agents, stress reducers, anti-pitting agents, and combinations of the foregoing; and
v. a pH buffer.

In one embodiment, the copper layer is formed on features formed in a photoresist layer of an IC device. The features may have a copper seed layer formed thereon and the copper layer is formed on the copper seed layer by electroplating, such as with an acid copper electroplating bath. In one embodiment, the electronic device (i.e., IC device) may be immersed in the copper electroplating bath for between about 1 and about 10 minutes, preferably between 2 and about 7 minutes, more preferably about 3 to about 5 minutes to deposit a layer of copper on the copper seed layer. The copper plating bath is typically maintained at a temperature of between about 20° C. and about 40° C., more preferably at about ambient temperature while the substrate is being immersed in the plating bath. The layer of copper deposited on the features preferably has a thickness of between about 1 and about 10 microns, preferably about 2 and about 9 microns, more preferably about 7 to about 8 microns. Thereafter, the electronic device is preferably rinsed prior to being brought into contact with the rhenium-cobalt electroplating composition described herein.

The rhenium-cobalt electrodeposition step is preferably conducted at a bath temperature in the range of about 20° C. to about 80° C., preferably about 23° C. to about 75° C., more preferably 25° C. to about 70° C. The plating time is about 0.25 minute to about 60 minutes, preferably about 0.50 minute to about 50 minutes, more preferably 0.75 minute to about 45 minutes. The current density may be in the range of about 0.05 to about 20 ASD, preferably about 0.1 to about 15 ASD, more preferably 0.2 to about 10 ASD. Optionally, the current may be pulsed, which can provide improvement in the uniformity of the deposit. On/off pulses and reverse pulses can be used.

The metallizing substrate (i.e., electronic device) is preferably contacted with the rhenium-cobalt electroplating composition by immersing the metallizing substrate in the electrolytic composition. An electrolytic current is delivered from the power source to the electrolytic composition in the circuit, thereby depositing a rhenium-cobalt alloy layer on the copper layer of the electronic device.

In one embodiment, the rhenium-cobalt electroplating bath may be agitated during use, although agitation is not required. If agitation is used, any suitable agitation method may be utilized with the process described herein including sparging with air or inert gas, workpiece agitation, impingement, or the like. In addition, the electronic device may be rotated in the electroplating solution. Alternatively, instead of immersing the electronic device into the electroplating solution, the electronic device maybe contacted with the electroplating solution by pumping, spraying or other means known to those skilled in the art.

In a preferred embodiment, the rhenium-cobalt electroplating composition is at least substantially free of other metal ions, meaning that the content of other metal ions is less than about 1% by weight, more preferably less than 0.1% by weight, most preferably less than about 0.01% by weight. Most preferably, the rhenium-cobalt electroplating composition is free of any metal ions except cobalt ions and rhenium ions.

As described herein, in order to solve the problems of slowing the growth of intermetallic compounds and storage stability after annealing and/or high temperature storage, the present invention addresses the following technical issues:
a. Utilization of an electrodeposition composition containing rhenium and cobalt. The rhenium-cobalt alloy acts as a barrier layer between copper and tin layers. The rhenium percentage in the alloy is greater than 50 wt. %, preferably greater than 60 wt. %, or greater than 70 wt. %, or greater than 80 wt. % or greater than 90 wt. %, which slows down the growth of intermetallic compounds and reduces their formation rate.
b. Implementation of a process for metal electrodeposition that involves depositing the rhenium-cobalt alloy barrier layer between copper and tin layers. The deposition process is crucial in ensuring the effectiveness of the barrier layer in reducing intermetallic compound growth and maintaining a stable interface.
c. Stacking of multiple devices and circuit layers is a key aspect of 3D-integration, which can improve integrated circuit performance by increasing bandwidth, shortening latency, and lowering power consumption. The stacking process also helps to reduce the total volume of solder available for intermetallic compound formation, thus increasing the criticality of the copper-barrier-solder stack interaction.
d. Creating fine-pitch applications in additive manufacturing technology where the intermetallic compounds start to dominate the mechanical and electrical properties of an entire bump. The additive manufacturing process allows for the precise addition of rhenium in higher than 50 wt. % concentration as an alloying metal to the cobalt diffusion barrier.

As can be seen with the process described herein, compared with existing technologies, there are several significant beneficial effects of the present invention.

The rhenium-cobalt electroplating composition is also preferably at least substantially free of copper ions. Although very minor copper contamination may be difficult to avoid, especially carry over contamination from the acid copper electroplating bath, it is particularly preferred that the copper ion content of the bath is no more than 20 ppb, e.g., in the range of 0.1 ppb to 20 ppb. In compositions defined herein, “substantially free of copper ions” means that there are less than 20 ppb copper ions in solution.

The source of cobalt ions is preferably selected from the group consisting of cobalt sulfate, cobalt chloride, chloride sulfamate, hydrates thereof, and combinations of one or more of the foregoing. In one embodiment, the cobalt ion concentration in the rhenium-cobalt electroplating solution is typically in the range of about 0.2 and about 50 g/L, preferably about 0.5 and about 40 g/L, more preferably 1.0 and about 35 g/L.

The source of rhenium ions is preferably a rhenate or a perrhenate salt, such as perrhenic acid, sodium perrhenate, potassium perrhenate, ammonium perrhenate, calcium perrhenate, tetrabutylammonium perrhenate and other similar salts. In one embodiment, the rhenium ion concentration in the rhenium cobalt electroplating solution is typically in the range of about 0.2 and about 50 g/L, preferably about 0.5 and about 35 g/L, more preferably 1.0 and about 25 g/L. While the concentrations described herein are believed to provide a good result in terms of the concentration of rhenium in the resulting deposit, there is not believed to be an upper limit to the concentration of rhenium ions used in the composition as a higher concentration of rhenium would lead to a plated alloy having a greater rhenium concentration that would provide a beneficial performance to the barrier. On the other hand, if the rhenium concentration is too low, the plated alloy would contain less than 50 wt. % rhenium and thus not serve as a good barrier layer.

In one embodiment, the rhenium-cobalt electroplating composition also optionally, but preferably comprises a complexing or chelating agent. Examples of suitable complexing agents include, but are not limited to, ethylenediaminetetraacetic acid (EDTA), oxalic acid, citric acid, malonic acid, succinic acid, glutaric acid, lactic acid, gluconic acid, tartaric acid, malic acid, glycine, other amino acids, and the like. The concentration of the complexing agent will depend in part on the particular complexing agent that is used. In one embodiment, the concentration of the complexing agent is in the range of about 10 g/L to about 200 g/L, more preferably about 30 g/L to about 150 g/L.

The rhenium-cobalt electroplating composition, also optionally, but preferably comprises a buffer to stabilize the pH, which may be an acid such as sulfuric acid, nitric acid, hydrochloric acid, boric acid, or an organic acid. In one embodiment, the acid comprises sulfuric acid. In another embodiment, the acid is boric acid (H₃BO₃), which may be incorporated into the composition in a concentration between about 5 and about 50 g/L, preferably between about 15 and about 40 g/L. The pH of the rhenium-cobalt electroplating composition is preferably maintained in the range of about 2.5 to about 7. In one embodiment, the pH of the rhenium-cobalt composition is preferably maintained in a range of less than 6.5, more preferably in a range of about 3 to about 6.

As described herein, in one embodiment, the rhenium-cobalt electroplating composition comprises one or more additives selected from the group consisting suppressors, uniformity enhancers, depolarizing compounds, levelers, accelerators, surfactants, wetting agents, stress reducers, anti-pitting agents, which may be included in various combinations.

If used, the one or more uniformity enhancing compounds comprise aminic polyol compounds or derivatives thereof. A preferred uniformity enhancer is ethoxylated, propoxylated triisopropanolamine. In one embodiment, the uniformity enhancer has a molecular weight of about 5000 g/mol. Other preferred uniformity enhancing compounds include ethoxylated, propoxylated ethylene diamine, ethoxylated, propoxylated diethylene triamine and ethoxylated, propoxylated triethylenetetramine. If used, the concentration of the uniformity enhancer is preferably between about 10 and about 4000 mg/L, and more preferably between about 100 and about 2000 mg/L, and most preferably between about 250 and about 1000 mg/L.

If used, the one or more depolarizing compounds comprise terminal unsaturated compounds or derivatives thereof, which are capable of depolarizing the plating potential. In one embodiment, the depolarizing compound may be selected from the group consisting of sodium propargyl sulfonate, acetylenedicarboxylic acid, acrylic acid, propiolic acid, vinyl phosphonate, and mixtures thereof. One preferred depolarizing compound is sodium propargyl sulfonate. If used, the concentration of the depolarizing compound is preferably between about 0.1 and about 5000 mg/L, and more preferably between about 10 and about 1000 mg/L, and most preferably between about 100 and about 500 mg/L.

In one embodiment, the rhenium-cobalt electroplating composition is also essentially free of chloride ions, meaning that the chloride content is less than about 1 ppm, more preferably less than 0.1 ppm.

In one embodiment, the rhenium-cobalt electroplating composition is also preferably free of any functional concentration of reducing agents effective to reduce cobaltous ions (Co²⁺) to metallic cobalt (Co⁰). By “functional concentration” what is meant is any concentration of a reducing agent that is either effective to reduce rhenium ions or cobaltous ions in the absence of electrolytic current or is activated by an electrolytic field to react with the rhenium ions or cobaltous ions.

In addition, the rhenium-cobalt electroplating composition is preferably at least essentially free of dispersed particles, meaning that there are no or virtually no macroscopic particulate solids in the solution that are dispersed and would negatively interfere with the metal electroplating process.

In one preferred embodiment, the rhenium-cobalt electroplating composition does not contain and is preferably at least substantially free of an accelerator or a depolarizer. In other preferred embodiments, the rhenium-cobalt electroplating composition does not contain and is preferably at least substantially free of a leveler.

In one embodiment, the rhenium-cobalt electroplating composition is substantially free of divalent sulfur compounds if the concentration of divalent sulfur in the plating solution is not greater than 1 mg/l. Preferably, the concentration of compounds containing divalent sulfur atoms is not greater than 0.1 mg/l. Still more preferably, the concentration of divalent sulfur atoms is below the detection level using analytical techniques common to those skilled in the art of metal plating. In one embodiment, to reduce internal stress in the rhenium-cobalt deposit, the rhenium-cobalt electroplating composition can include a stress reducer such as saccharin, 1,3,6-napthalene sulfonic acid, P-toluene sulfonamide, thiophen-2-sulfonic acid, formaldehyde chloral hydrate o-sulfo benzaldehyde, coumarin, o-hydroxy cinnamic acid, diethyl maleate, 2-butyne-1,4-diol 2-butyne-1,4-disulfonic acid, ethyl cyanohydrin, p-amino azo benzene, thiourea, allyl thiourea, hydroquinone, sodium hydrosulfite, sodium thiosulfate, p-aminophenol, sodium naphthalene trisulfonate, formic acid, gluconic acid, methane sulfonic acid, ethane sulfonic acid, acrylic acid methacrylic acid, glyoxylic acid, and combination of the foregoing. These stress reducers may be included in the electroplating composition at a concentration within the range of about 0.01 g/L to about 10 g/L. In one embodiment, the stress reducer comprises saccharin at a concentration between about 0.01 g/L and about 5 g/L, more preferably at a concentration of about 0.10 to about 0.20 g/L.

It has also been found that certain depolarizing compounds can function in conjunction with the suppressor compounds as described herein. These compounds depolarize the plating potential to efficiently plate interconnect features.

In one embodiment, the rhenium-cobalt electroplating composition comprises one or more suppressor compounds. In one embodiment, the one or more suppressor compounds comprise acetylenic alcohol compounds or derivatives thereof as further described herein. If used, the concentration of the suppressor is preferably between about 1 and about 500 mg/L, and more preferably between about 5 and about 200 mg/L, more preferably between about 1 mg/L and about 70 mg/L, and most preferably between about 20 and about 50 mg/L.

In one embodiment, the acetylenic suppressor comprises a reaction product of an alkoxylated propargyl alcohol or propargyl alcohol with a second component. Examples of suitable acetylenic suppressors include, but are not limited to, reaction products of alkoxylated propargyl alcohol or propargyl alcohol with glycidol, propylene oxide, glycidol and propylene oxide, or propylene glycol and glycidol. In one embodiment, the alkoxylated propargyl alcohol is ethoxylated propargyl alcohol. However, it is also contemplated that other alkoxylated propargyl alcohols would also be used in the compositions described herein. Examples of initiators and reacting species for preparing acetylenic suppressors in accordance with the present invention are shown below in Table 1.

In one embodiment, the rhenium-cobalt alloy layer has a thickness of less than about 2 μm, such as between 50 nm and about 2 μm, preferably between about 75 nm and about 1 μm.

TABLE 1
Initiators and reacting species for use in preparing acetylenic suppressors
Initiators

| | | |
|---|---|---|
| 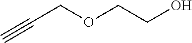 | 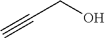 | 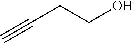 |
| 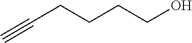 | 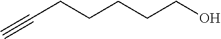 | 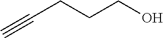 |

Reacting species

| | | |
|---|---|---|
| 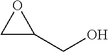 | 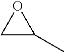 | 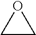 |
| 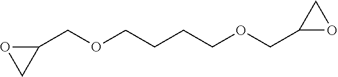 [SMILES: C(CCOCC1CO1)COCC1CO1] | | |

Preferred Products

| | |
|---|---|
| 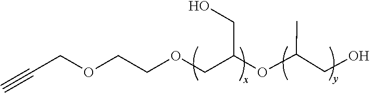 | 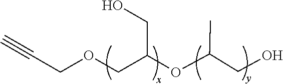 |
| 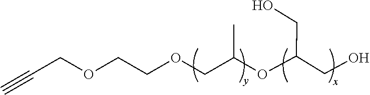 | 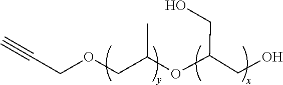 |

In one embodiment, x and y are between 0 and 20, more preferably between 0 and 10. In another preferred embodiment, one of x or y is at least 1. Examples of preferred ratios included, but are not limited to:
x is 0, y is 1 to 3;
y is o and x is 1 to 7; and
x is 1˜4 and y is 1-4.

Other ratios of x and y would also be known to those skilled in the art and are usable in the present invention.

Table 2 depicts several examples of preferred acetylenic suppressors in accordance with the present invention and as formulated using the initiators and reacting species described herein.

TABLE 2
Preferred specific acetylenic suppressors

| | |
|---|---|
| Ethoxylated propargyl alcohol + glycidol (Compound 1) | 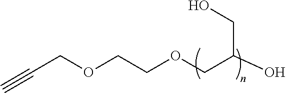 |
| Ethoxylated propargyl alcohol + propylene oxide (Compound 2) | 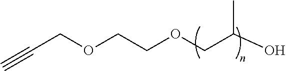 |
| Ethoxylated propargyl alcohol + glycidol + propylene oxide (Compound 3) | 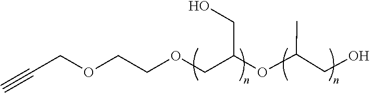 |
| ethoxylated propargyl alcohol + propylene oxide + glycidol (Compound 4) | 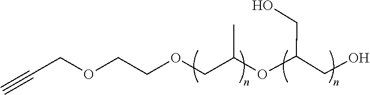 |

In one embodiment, n is between 0 and 20, more preferably between 0 and 10, most preferably between 1 and 7.

After the rhenium-cobalt alloy layer is electrodeposited on the electroplated copper layer, a tin layer is deposited on the rhenium-cobalt alloy layer such as by electroplating. In one embodiment, the tin layer is a tin or a tin alloy layer such as a tin-silver alloy containing a small concentration of silver. In one embodiment, the silver content is the range of about 1 to about 5 wt. %, more preferably about 1.5 to about 3.5 wt. %. In one embodiment, the tin plating bath is maintained at a temperature within the range of about 20 to about 40° C., more preferably at a about room temperature. The electronic device is contacted with the tin plating bath for about 10 to about 90 seconds, more preferably about 30 to about 60 seconds at a current density of about 5 to about 15 ASD, more preferably about 8 to about 12 ASD to a thickness of about 0.5 to about 5 microns, more preferably about 1 to about 3 microns.

Once the copper, rhenium cobalt alloy, and tin layers have been deposited on the electronic substrate, the electronic device is subjected to further processing steps such as annealing or reflow, which may also be followed by high temperature storage.

During annealing, electronic devices (i.e., IC chips) are heated to a well-defined temperature for a specific amount of time in a conditioned atmosphere (inert, oxidizing, reducing). The temperature, time and type of atmosphere used in an annealing process depends on the purpose of the anneal and the type of surface being treated. Annealing may be used to remove impurities (mostly oxygen) from the surface layers or to cause implanted ions to diffuse further into the silicon. In one embodiment, the electronic devices are annealed at a temperature in the range of about 150 to about 300° C., more preferably about 200 to about 220° C. for at least about 1 hour, or at least about 2 hours, or at least about 3 hours.

During reflow, the materials are subjected to controlled heat such that the tin layer is melted to create a permanent joint, which may be accomplished in a reflow oven. Preheat is a first state of the reflow process during which the entire IC chip assembly or other substrate claims towards dwell temperature such that the entire IC chip assembly is maintained at the reflow temperature. melted above the melting point of the tin layer to the solder pin. The reflow zone (also referred to as the “time above reflow”), and is the part of the process where the maximum temperature is reached. An important consideration is peak temperature, which is the maximum allowable temperature of the entire process. A common peak temperature is 20-40° C. above liquidus. As described in the examples below, reflow may occur at a peak temperature of between about 225 and 250° C. for between about 10 seconds and 1 minute.

After annealing, the electronic substrate may be further processed by subjecting the annealed integrated circuit device to high temperature storage conditions for a period of time. In one embodiment, the temperature is in the range of about 150° C. and the storage time is at least about 100 hours, or at least about 200 hours, or at least about 300 hours, or at least about 500 hours, or at least about 1000 hours.

As described herein, the use of a rhenium-cobalt alloy as a barrier layer between copper and tin layers can significantly enhance the performance of integrated circuits. By suppressing the growth of intermetallic compounds, the mechanical and electrical properties of the integrated circuit device are improved, leading to increased bandwidth, reduced latency, and lowered power consumption.

Furthermore, the addition of rhenium in higher that 50 wt. % concentration as an alloying metal to the cobalt diffusion barrier can create a more stable interface. This stability is crucial in preventing the interdiffusion of the copper and tin layers, which can lead to the formation of intermetallic compounds that can negatively impact the performance of the device.

Additionally, the invention described herein supports the growing demand for 3D-integration in the semiconductor industry. By stacking multiple devices and circuit layers, the overall performance of integrated circuits can be significantly improved. This advanced integration technique is particularly beneficial for fine-pitch applications, where the total volume of solder available for intermetallic compound formation is reduced.

Finally, while the current technology requires precise control to add rhenium at a concentration of greater than 50 wt. % as an alloying metal to the cobalt diffusion barrier, the present invention greatly simplifies this process. This simplification can potentially reduce the complexity and cost of the manufacturing process, making it more feasible for large-scale production.

Thus, it can be seen that the invention described herein provides a superior alternative to existing technology by enhancing the performance, improving the stability, supporting the advanced integration, and simplifying the manufacturing process.

In one embodiment, the present invention relates generally to a rhenium-cobalt alloy barrier layer that contains at least 50 wt. % rhenium, or at least 60 wt. % rhenium, or at least 70 wt. % rhenium, or at least 80 wt. % rhenium, or at least 90 wt. % rhenium.

In one embodiment, the present invention also relates generally to an electronic device comprising one or more electrical interconnections, wherein the one or more electrical interconnections comprise one or features filled with a conducting material, wherein the conducting material comprises:
1. a copper layer;
2. a rhenium-cobalt alloy barrier layer deposited on the copper layer, wherein the rhenium cobalt barrier layer comprises greater than 50 wt. % rhenium; and
3. a tin containing layer deposited on the rhenium-cobalt alloy barrier layer.

The present invention will now be described in reference to the following non-limiting examples.

X-ray fluorescence (XRF) was used to characterize the rhenium-cobalt alloy composition in all of the examples.

As used in the Examples, a focused ion beam (FIB) allows for cross-sectioning and imaging of materials to determine internal structure of the material. FIB prepared cross sections are used in SEM microscopy to examine products with small, difficult to access features. In the examples below, metal stack cross-sectioning is used to reveal all of the metal layers.

### EXAMPLES

### Example 1

MacDermid Alpha MICROFAB® Pure BP SC acid copper bath was made up according to the technical data sheet. A 30 mm×10 mm coupon with a 25 micron thick patterned photoresist comprising 15 micron diameter pads for bumps with copper seed layer was immersed into the acid copper bath and electroplated at ambient temperature for 4 minutes at 9 ASD for a thickness of 7 microns.

The coupon was rinsed and was then immersed into a rhenium cobalt electrolyte containing:
13.6 g/L rhenium metal;
10.5 g/L cobalt metal;
60 g/L of a complexing agent;
30 gl//L of one or more additives; and

One or more pH buffers to adjust the pH to 5.0

The coupon was electroplated at 60° C. for 3 minutes 45 seconds at 2 ASD to plate a 1.4 micron thick barrier layer.

The coupon was rinsed and was then immersed into MacDermid Alpha MICROFAB® TS-650 tin-silver bath (containing 1.8 wt. % Ag) and electroplating at ambient temperature for 36 seconds at 10 ASD to deposit a tin-silver alloy layer having a thickness of 1.4 microns.

The composition of the ReCo barrier was measured using XRF and found to contain 49.5 wt. % Re with the balance of cobalt.

The coupon was annealed at a temperature of 200° C. for a time period of 2 hours. A FIB cross-section was prepared and the IMC layer was measured at 0.0 micron average thickness after annealing. However, the high cobalt concentration of the barrier resulted in cobalt diffusion into the copper layer as shown in FIG. 1.

### Comparative Example 2

MacDermid Alpha MICROFAB® Pure BP SC acid copper bath was made up according to the technical data sheet. A 30 mm×10 mm coupon with a 25 micron thick patterned photoresist comprising 15 micron diameter pads for bumps with copper seed layer was immersed into the acid copper bath and electroplated at ambient temperature for 4 minutes at 9 ASD for a thickness of 7 microns.

The coupon was rinsed and was then immersed into MacDermid Alpha NOVAFAB® Ni200B bath. The coupon was electroplated with pure nickel at 55° C. for 5 minutes at 3 ASD to plate a 3 micron thick barrier layer.

The coupon was rinsed and was then immersed into MacDermid Alpha MICROFAB® TS-650 tin-silver bath (containing 1.8 wt. % Ag) at ambient temperature for 36 seconds at 10 ASD to deposit a tin-silver alloy layer having a thickness of 1.4 microns.

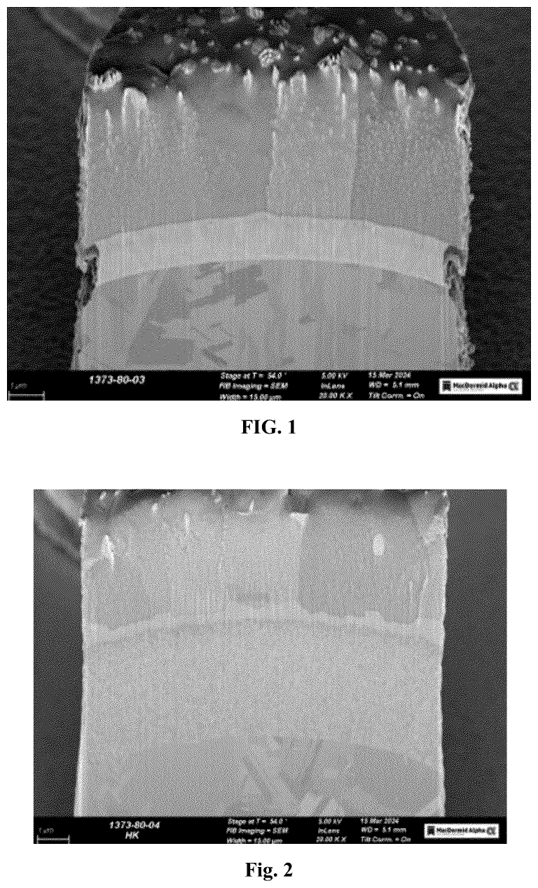

The coupon was annealed at a temperature of 200° C. for a time period of 2 hours. A FIB cross-section was prepared and the IMC was measured at 0.5 micron average thickness after annealing. As shown in FIG. 2, the nickel barrier layer also resulted in a significant quantity of nickel diffusion into the copper layer and the interface between the barrier layer and the copper layer was not stable.

### Example 3

MacDermid Alpha MICROFAB® Pure BP SC acid copper bath was made up according to the technical data sheet. A 30 mm×10 mm coupon with a 25 micron thick patterned photoresist comprising 15 micron diameter pads for bumps with copper seed layer was immersed into the acid copper bath and electroplated at ambient temperature for 4 minutes at 9 ASD for a thickness of 7 microns.

The coupon was rinsed and was then immersed into a rhenium cobalt electrolyte containing:
13.6 g/L rhenium metal;
2.1 g/L cobalt metal;
60 g/L of a complexing agent;
30 gl//L of one or more additives; and
One or more pH buffers to adjust the pH to 5.0

The coupon was electroplated at 50° C. for 5 minutes at 3 ASD to plate a 0.7 micron thick barrier layer.

The coupon was rinsed and was then immersed into MacDermid Alpha MICROFAB® TS-650 tin-silver bath (containing 1.8 wt. % Ag) alloy at ambient temperature for 36 seconds at 10 ASD to deposit a tin-silver alloy layer having a thickness of 3 microns.

The composition of the ReCo barrier was measured using XRF and found to contain 80 wt. % Re with the balance of cobalt.

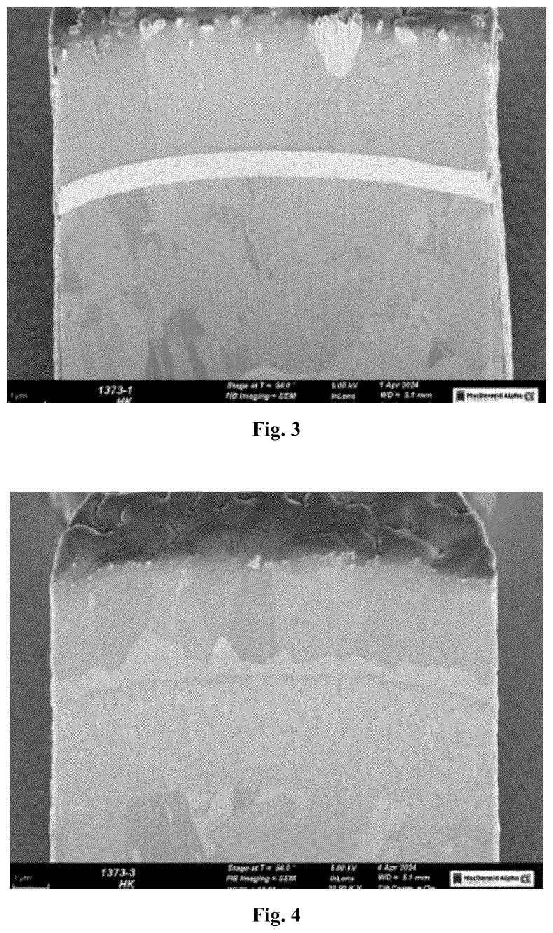

The coupon was annealed at a temperature of 200° C. for a time period of 3 hours. A FIB cross-section was prepared and the IMC was measured at 0.0 micron average thickness after annealing. As shown in FIG. 3, there was no diffusion of cobalt up into the copper layer.

### Comparative Example 4

MacDermid Alpha MICROFAB® Pure BP SC acid copper bath was made up according to the technical data sheet. A 30 mm×10 mm coupon with a 25 micron thick patterned photoresist comprising 15 micron diameter pads for bumps with copper seed layer was immersed into the acid copper bath and electroplated at ambient temperature for 4 minutes at 9 ASD for a thickness of 3 microns.

The coupon was rinsed and was then immersed into MacDermid Alpha MICROFAB® Ni200B bath. The coupon was electroplated at 55° C. with pure nickel for 5 minutes at 3 ASD to plate a 3 micron thick barrier layer.

The coupon was rinsed and was then immersed into MacDermid Alpha MICROFAB® TS-650 tin-silver bath (containing 1.8 wt. % Ag) at ambient temperature for 36 seconds at 10 ASD to deposit a tin-silver alloy layer having a thickness of 3 microns.

The coupon was annealed at a temperature of 200° C. for a time period of 3 hours. A FIB cross-section was prepared and the IMC was measured at 0.6 micron average thickness after annealing. As shown in FIG. 4, the nickel barrier layer also resulted in a significant quantity of nickel diffusion into the copper layer and the interface between the barrier layer and the copper layer was not stable.

### Example 5

MacDermid Alpha MICROFAB® Pure BP SC acid copper bath was made up according to the technical data sheet. A 30 mm×10 mm coupon with a 25 micron thick patterned photoresist comprising 15 micron diameter pads for bumps with copper seed layer was immersed into the acid copper bath and electroplated at ambient temperature for 4 minutes at 9 ASD for a thickness of 7 microns.

The coupon was rinsed and was then immersed into the rhenium cobalt electrolyte of Example 3. The coupon was electroplated at 50° C. for 5 minutes at 3 ASD to plate a 0.7 micron thick barrier layer.

The coupon was rinsed and was then immersed into MacDermid Alpha MICROFAB® TS-650 tin-silver bath (containing 1.8 wt. % Ag) at ambient temperature for 36 seconds at 10 ASD to deposit a tin-silver alloy layer having a thickness of 3 microns.

The composition of the ReCo barrier was measured using XRF and found to contain 80.0 wt. % Re with the balance of cobalt.

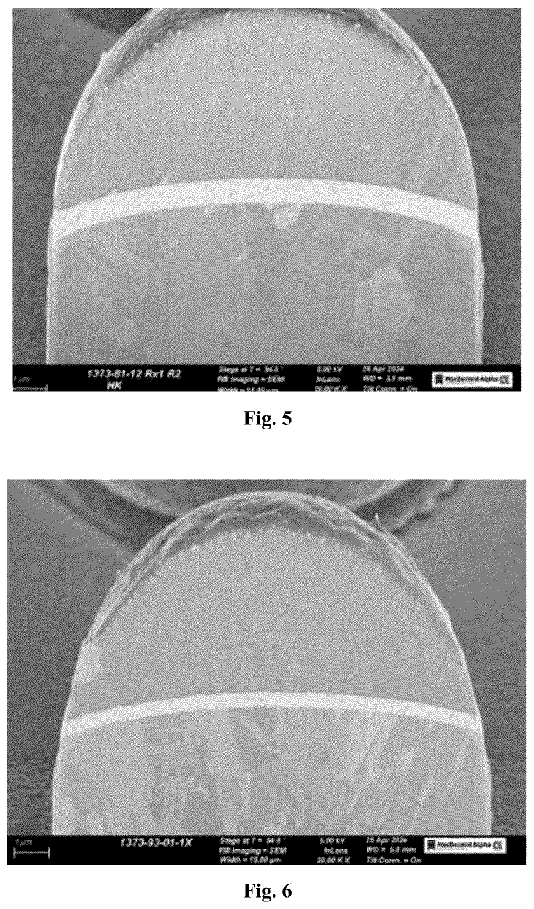

The coupon was reflowed 1× at a peak temperature of 240° C. and a duration of 15 seconds. A FIB cross-section was prepared and the IMC was measured at 0.0 micron average thickness after annealing. As shown in FIG. 5, there was no diffusion of cobalt into the copper layer.

### Example 6

MacDermid Alpha MICROFAB® Pure BP SC acid copper bath was made up according to the technical data sheet. A 30 mm×10 mm coupon with a 25 micron thick patterned photoresist comprising 15 micron diameter pads for bumps with copper seed layer was immersed into the acid copper bath and electroplated at ambient temperature for 4 minutes at 9 ASD for a thickness of 7 microns.

The coupon was rinsed and was then immersed into a rhenium cobalt electrolyte containing:
13.6 g/L rhenium metal;
0.2 g/L cobalt metal;
60 g/L of a complexing agent;
30 g//L of one or more additives; and
One or more pH buffers to adjust the pH to 4.0

The coupon was electroplated at 50° C. for 10 minutes 45 seconds at 2 ASD to plate a 0.5 micron thick barrier layer.

The coupon was rinsed and was then immersed into MacDermid Alpha MICROFAB® TS-650 tin-silver bath (containing 1.8 wt. % Ag) at ambient temperature for 36 seconds at 10 ASD to deposit a tin-silver alloy layer having a thickness of 3 microns.

The composition of the ReCo barrier was measured using XFR and found to contain 97 wt. % Re with the balance of cobalt.

The coupon was reflowed 1× at a peak temperature of 240° C. and a duration of 15 seconds. A FIB cross-section was prepared and the IMC was measured at 0.0 micron average thickness after annealing. As shown in FIG. 6, there was no diffusion of cobalt into the copper layer.

### Comparative Example 7

MacDermid Alpha MICROFAB® Pure BP SC acid copper bath was made up according to the technical data sheet. A 30 mm×10 mm coupon with a 25 micron thick patterned photoresist comprising 15 micron diameter pads for bumps with copper seed layer was immersed into the acid copper bath and electroplated at ambient temperature for 4 minutes at 9 ASD for a thickness of 3 microns.

The coupon was rinsed and was then immersed into MacDermid Alpha MICROFAB® Ni200B. The coupon was electroplated at 55° C. with pure nickel for 5 minutes to plate a 3 micron thick barrier layer.

The coupon was rinsed and was then immersed into MacDermid Alpha MICROFAB® TS-650 tin-silver bath (containing 1.8 wt. % Ag) at ambient temperature for 36 seconds at 10 ASD to deposit a tin-silver alloy layer having a thickness of 3 microns.

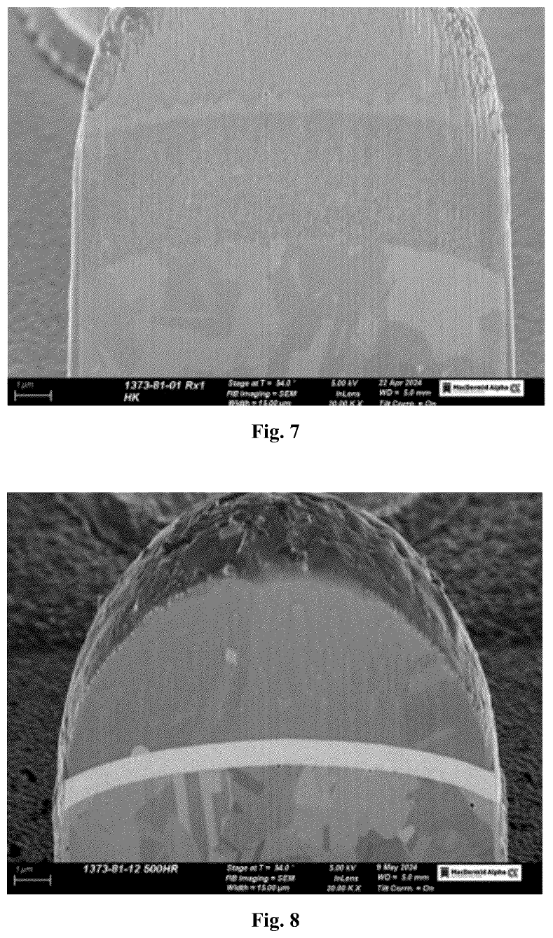

The coupon was reflowed 1× at a peak temperature of 240° C. and a duration of 15 seconds. A FIB cross-section was prepared and the IMC was measured at 0.5 micron average thickness after annealing. As shown in FIG. 7, there was significant diffusion of nickel into the copper layer and the interface between the barrier layer and the copper layer was not stable.

### Example 8

MacDermid Alpha MICROFAB® Pure BP SC acid copper bath was made up according to the technical data sheet. A 30 mm×10 mm coupon with a 25 micron thick patterned photoresist comprising 15 micron diameter pads for bumps with copper seed layer was immersed into the acid copper bath and electroplated at ambient temperature for 4 minutes at 9 ASD for a thickness of 7 microns.

The coupon was rinsed and was then immersed into the rhenium cobalt electrolyte of Example 3. The coupon was electroplated at 50° C. for 5 minutes at 3 ASD to plate a 0.7 micron thick barrier layer.

The coupon was rinsed and was then immersed into MacDermid Alpha MICROFAB® TS-650 tin-silver bath. The coupon was electroplated with SnAg (containing 1.8 wt. % Ag) at ambient temperature for 36 seconds at 10 ASD to deposit a tin-silver alloy layer having a thickness of 3 microns.

The composition of the ReCo barrier was measured using XFR and found to contain 80.0 wt. % Re with the balance of cobalt.

The coupon was reflowed 1× at a peak temperature of 240° C. and a duration of 15 seconds and then heat treated under high temperature storage conditions of 150° C. for 500 hours.

A FIB cross-section was prepared and the IMC was measured at 0.0 micron average thickness after high temperature storage. As shown in FIG. 8, there was no diffusion of cobalt into the copper layer.

A summary of the results of Examples 1 to 8 is shown below in Table 1.

TABLE 1
Summary of results

| | T | | CD | Thickness | | Wt. % | IMC |
|---|---|---|---|---|---|---|---|
| | (° C.) | Time | (ASD) | μ | Annealing | Re | μ |
| Ex. 1 | 60 | 3 min. 45 sec. | 2 | 1.4 | 200° C., 2 h | 49.5 | 0.0 |
| Comp. Ex. 2 | 55 | 5 min | 3 | 3 | 200° C., 2 h | — | 0.5 |
| Ex. 3 | 50 | 5 min | 3 | 0.7 | 200° C., 3 h | 80.0 | 0.0 |
| Comp. Ex. 4 | 50 | 5 min | 3 | 3 | 200° C., 3 h | — | 0.6 |
| Ex. 5 | 50 | 5 min | 3 | 0.7 | Reflow¹ | 80.0 | 0.0 |
| Ex. 6 | 50 | 10 min | 3 | 0.5 | Reflow¹ | 97.0 | 0.0 |
| Comp. Ex. 7 | 55 | 5 | 3 | 3 | Reflow¹ | — | 0.5 |
| Ex. 8 | 50 | 5 min | 3 | 0.7 | Reflow² | 80.0 | 0.0 |

Reflow¹—Reflow 1X at a peak temperature of 240° C. and a duration of 15 seconds
Reflow²—Reflow 1X at a peak temperature of 240° C. and a duration of 15 seconds followed by heat treatment under high temperature storage conditions of 150° C. for 500 hours.

### Additional Embodiments

Clause 1. A method of creating one or more metal interconnects in an electronic device, wherein the electronic device comprises one or more features within which the one or more metal interconnects are created, the method comprising the steps of:
   a. depositing a copper layer on the one or more features;
   b. depositing a rhenium-cobalt alloy layer on the copper layer; and
   c. depositing a tin or tin alloy layer on the rhenium-cobalt alloy layer;
      wherein the rhenium-cobalt alloy layer comprises greater than 50 wt. % rhenium.
Clause 2. The method according to Clause 1, wherein the rhenium-cobalt alloy layer comprises greater than 60 wt. % rhenium, or greater than 70 wt. % rhenium, or greater than 80 wt. % rhenium, or greater than 90 wt. % rhenium.
Clause 3. The method according to Clause 1 or 2, wherein the rhenium-cobalt alloy layer is formed by bringing the electronic device as a cathode and an anode into contact with an electroplating composition to electrodeposit the rhenium-cobalt alloy layer on the copper layer of the electronic device.
Clause 4. The method according to any of Clauses 1 to 3, wherein the rhenium-cobalt alloy layer has a thickness of about 50 nm to about 2 μm.
Clause 5. The method according to Clause 3 or Clause 4, wherein the electroplating composition comprises:
   i. a source of cobalt ions;
   ii. a source of rhenium ions;
   iii. optionally, a complexing agent;
   iv. one or more additives selected from the group consisting suppressors, uniformity enhancers, depolarizing compounds, levelers, accelerators, surfactants, wetting agents, stress reducers, anti-pitting agents, and combinations of the foregoing; and;
   v. and
   vi. a pH buffer.
Clause 6. The method according to any of the preceding Clauses, further comprising the step of annealing the electronic device, wherein cobalt from the rhenium-cobalt alloy layer at least substantially does not diffuse into the copper layer.
Clause 7. The method according to any of the preceding Clauses, comprising the step of subjecting the electronic device to reflow at a peak temperature of between about 225 and 250° C. for between about 10 seconds and 1 minute.
Clause 8. The method according to Clause 7, further comprising the step of heating the electronic device under long term storage conditions of between about 150° C. and about 200° C. for at least 200 hours or at least 300 hours or at least 400 hours or at least 500 hours, wherein cobalt from the rhenium-cobalt alloy layer at least substantially does not diffuse into the copper layer.
Clause 9. The method according to Clause 7 or Clause 8, wherein a thickness of intermetallic compounds after annealing is less than 0.1 μm, preferably less than 0.01 μm, more preferably substantially 0.0 μm.
Clause 10. The method according to Clause 3, wherein the source of cobalt ions is selected from the group consisting of cobalt sulfate, cobalt chloride, cobalt sulfamate, and combinations of one or more of the foregoing, more preferably wherein the source of cobalt ions comprises cobalt sulfate heptahydrate.
Clause 11. The method according to Clause 3 or Clause 10, wherein the source of rhenium ions comprises a perrhenate compound, wherein the perrhenate compound is selected from the group consisting of sodium perrhenate, ammonium perrhenate, potassium perrhenate, calcium perrhenate, and combinations of one or more of the foregoing.
Clause 12. An electronic device comprising one or more electrical interconnections, wherein the one or more electrical interconnections comprise one or features filled with a conducting material, wherein the conducting material comprises:
   a. a copper layer;
   b. a rhenium-cobalt alloy barrier layer deposited on the copper layer, wherein the rhenium-cobalt alloy barrier layer comprises greater than 50 wt. % rhenium; and
   c. a tin containing layer deposited on the rhenium cobalt barrier layer.
Clause 13. The electronic device according to Clause 12, wherein the electronic device is an integrated circuit chip.
Clause 14. The electronic device according to Clause 12 or Clause 13, wherein the rhenium-cobalt alloy barrier layer has a thickness of between about 500 nm and about 2 μm.
Clause 15. The electronic device according to any of Clause 12 to 14, wherein the electronic device is annealed and cobalt from the rhenium-cobalt alloy layer at least substantially does not diffuse into the copper layer.
Clause 16. The electronic device according to any of Clause 12 to 15, wherein the electronic device is subjected to reflow at a peak temperature of between about 225 and 250° C. for between about 10 seconds and 1 minute.
Clause 17. The electronic device according to Clause 16, wherein the electronic device is heated under long term storage conditions of between about 150° C. and about 200° C. for at least 200 hours or at least 300 hours or at least 400 hours or at least 500 hours or at least about 1,000 hours, wherein cobalt from the rhenium-cobalt alloy layer at least substantially does not diffuse into the copper layer.

What is claimed is:

1. A method of creating one or more metal interconnects in an electronic device, wherein the electronic device comprises one or more features within which the one or more metal interconnects are created, the method comprising the steps of:
a. depositing a copper layer on the one or more features;
b. depositing a rhenium-cobalt alloy layer on the copper layer; and
c. depositing a tin or tin alloy layer on the rhenium-cobalt alloy layer;
wherein the rhenium-cobalt alloy layer comprises greater than 50 wt. % rhenium.

2. The method according to claim 1, wherein the rhenium-cobalt alloy layer comprises greater than 60 wt. % rhenium, or greater than 70 wt. % rhenium, or greater than 80 wt. % rhenium, or greater than 90 wt. % rhenium.

3. The method according to claim 1, wherein the rhenium-cobalt alloy layer is formed by bringing the electronic device as a cathode and an anode into contact with an electroplating composition to electrodeposit the rhenium-cobalt alloy layer on the copper layer of the electronic device.

4. The method according to claim 1, wherein the rhenium-cobalt alloy layer has a thickness of about 50 nm to about 2 μm.

5. The method of claim 3, wherein the electroplating composition comprises:
i. a source of cobalt ions;
ii. a source of rhenium ions;
iii. optionally, a complexing agent;
iv. one or more additives selected from the group consisting suppressors, uniformity enhancers, depolarizing compounds, levelers, accelerators, surfactants, wetting agents, stress reducers, anti-pitting agents, and combinations of the foregoing; and;
v. a pH buffer.

6. The method according to claim 1, further comprising the step of annealing the electronic device, wherein cobalt from the rhenium-cobalt alloy layer at least substantially does not diffuse into the copper layer.

7. The method according to claim 1, comprising the step of subjecting the electronic device to reflow at a peak temperature of between about 225 and 250° C. for between about 10 seconds and 1 minute.

8. The method according to claim 7, further comprising the step of heating the electronic device under long term storage conditions of between about 150° C. and about 200° C. for at least 200 hours or at least 300 hours or at least 400 hours or at least 500 hours, wherein cobalt from the rhenium-cobalt alloy layer at least substantially does not diffuse into the copper layer.

9. The method according to claim 7, wherein a thickness of intermetallic compounds after annealing is less than 0.1 μm, preferably less than 0.01 μm, more preferably substantially 0.0 μm.

10. The method according to claim 5, wherein the source of cobalt ions is selected from the group consisting of cobalt sulfate, cobalt chloride, cobalt sulfamate, and combinations of one or more of the foregoing, more preferably wherein the source of cobalt ions comprises cobalt sulfate heptahydrate.

11. The method according to claim 5, wherein the source of rhenium ions comprises a perrhenate compound, wherein the perrhenate compound is selected from the group consisting of sodium perrhenate, ammonium perrhenate, potassium perrhenate, calcium perrhenate, and combinations of one or more of the foregoing.

12. An electronic device comprising one or more electrical interconnections, wherein the one or more electrical interconnections comprise one or features filled with a conducting material, wherein the conducting material comprises:
a. a copper layer;
b. a rhenium-cobalt alloy barrier layer deposited on the copper layer, wherein the rhenium-cobalt alloy barrier layer comprises greater than 50 wt. % rhenium; and
c. a tin containing layer deposited on the rhenium cobalt barrier layer.

13. The electronic device according to claim 12, wherein the electronic device is an integrated circuit chip.

14. The electronic device according to claim 12, wherein the rhenium-cobalt alloy barrier layer has a thickness of between about 500 nm and about 2 μm.

15. The electronic device according to claim 12, wherein the electronic device is annealed and cobalt from the rhenium-cobalt alloy layer at least substantially does not diffuse into the copper layer.

16. The electronic device according to claim 12, wherein the electronic device is subjected to reflow at a peak temperature of between about 225 and 250° C. for between about 10 seconds and 1 minute.

17. The electronic device according to claim 16, wherein the electronic device is heated under long term storage conditions of between about 150° C. and about 200° C. for at least 200 hours or at least 300 hours or at least 400 hours or at least 500 hours or at least about 1,000 hours, wherein cobalt from the rhenium-cobalt alloy layer at least substantially does not diffuse into the copper layer.
